(19) United States
(12) Patent Application Publication
(10) Pub. No.: US 2006/0279240 A1
(43) Pub. Date: Dec. 14, 2006

(54) Actuating drive having an electric motor and a control device for controlling the speed of the electric motor

(75) Inventor: Dominic Lendi, Ebertwil (CH)

Correspondence Address: Maginot, Moore & Beck;Chase Tower, Suite 3250, 111 Monument Circle, Indianapolis, IN, 46204, US

(73) Assignee: Siemens Schweiz AG, Zurich (CH)

(21) Appl. No.: 11/441,783

(22) Filed: May 26, 2006

(30) Foreign Application Priority Data
May 27, 2005 (EP) EP05011434.7

(51) Int. Cl. H02P 7/00

(52) U.S. Cl. 318/268

(57) ABSTRACT

An actuating drive, which can be remotely controlled in a wireless fashion and is fed by a battery, for operating an actuator (5) between two final positions has a control device for controlling the speed of an electric motor (1). The actuating drive (60) has a changeover device (81) with the aid of which it can optionally be operated either in a first operating mode or in a second operating mode. The control device controls the speed to a first setpoint (ω_{SN}) in the first operating mode, and to a second setpoint (ω_{SL}) in the second operating mode. The first setpoint (ω_{SN}) is fixed in such a way that the energy consumption during operation of the actuator (5) is minimal, while the second setpoint (ω_{SL}) is fixed in such a way that the noise level (L) generated by the actuating drive in the second operating mode is lower than in the first operating mode. By programming a time controller (84) in a fashion appropriate to the application, the actuating drive (60) operates whenever possible in an optimum fashion in terms of energy and, when actually necessary, at the low noise level (L). The actuating drive (60) can therefore be used in a fashion saving battery energy even in the domestic sector.

### The invention relates to an actuating drive for operating an actuator in accordance with the preamble of claim 1.

An actuating drive in accordance with the invention is energy efficient and low in noise, and it can advantageously be used to operate a valve in heating, ventilation, refrigeration and air conditioning. In particular, the actuating drive can be used for the remote control of a radiator valve in a wireless fashion.

Remotely controllable hot water valves are known, for example, from DE2800704A, DE2952695A and DE4221094A.

WO99/15822A1 discloses an actuating drive for a thermostat valve in the case of which the speed of an electric motor can be controlled.

For the domestic sector—in particular for bedrooms—actuating drives are to be designed such that, in operation, they operate as quietly as possible. Actuating drives remotely controlled in a wireless fashion are generally operated with a battery whose replacement is attended by operational interruptions and costs. Consequently, the energy requirement is to be minimized in the case of a remotely controlled actuating drive.

It is the object of the invention to provide an actuating drive that can be remotely controlled in a wireless fashion and operates in the fashion that is energy efficient and quiet, and can therefore also be used in the domestic sector.

The said object is achieved according to the invention by the features of claim 1.

Advantageous refinements follow from the dependent claims.

Exemplary embodiments of the invention are explained in more detail below with the aid of the drawing, in which:

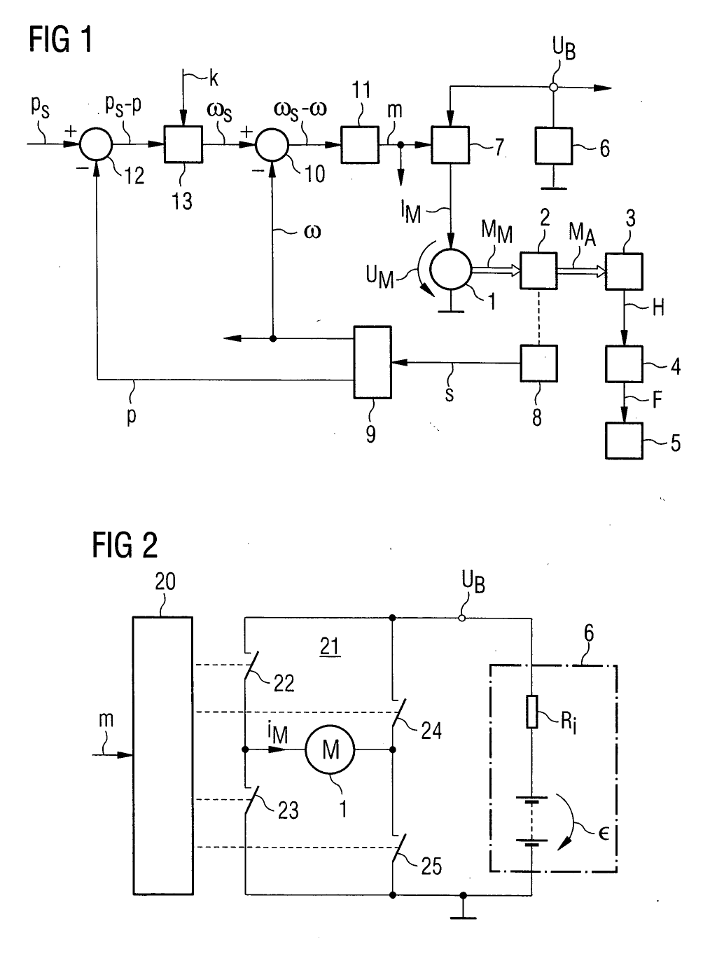

FIG. 1 shows a block diagram of a control device of an actuating drive,

FIG. 2 shows a block diagram relating to the mode of operation of a motor driver module,

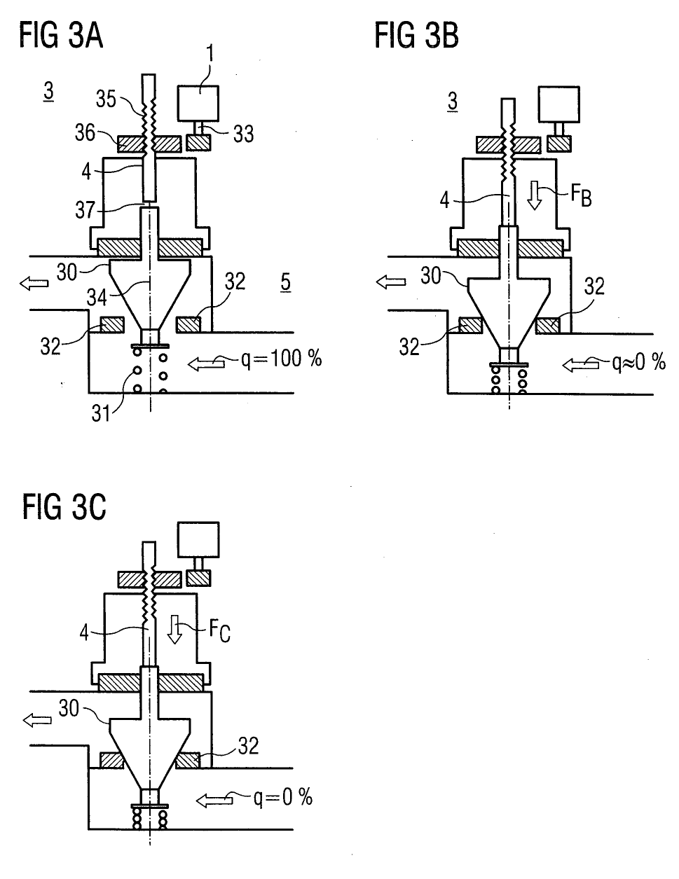

FIG. 3 shows states of an actuator,

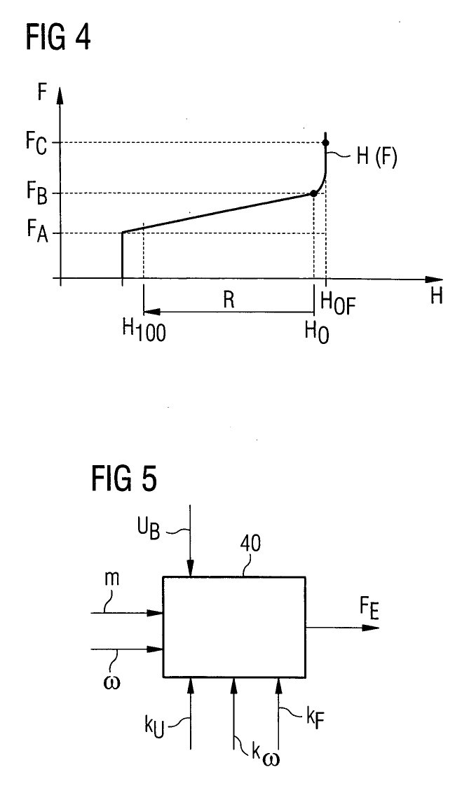

FIG. 4 shows a diagram relating to the profile of an actuating force,

FIG. 5 shows a computing module for calculating the actuating force,

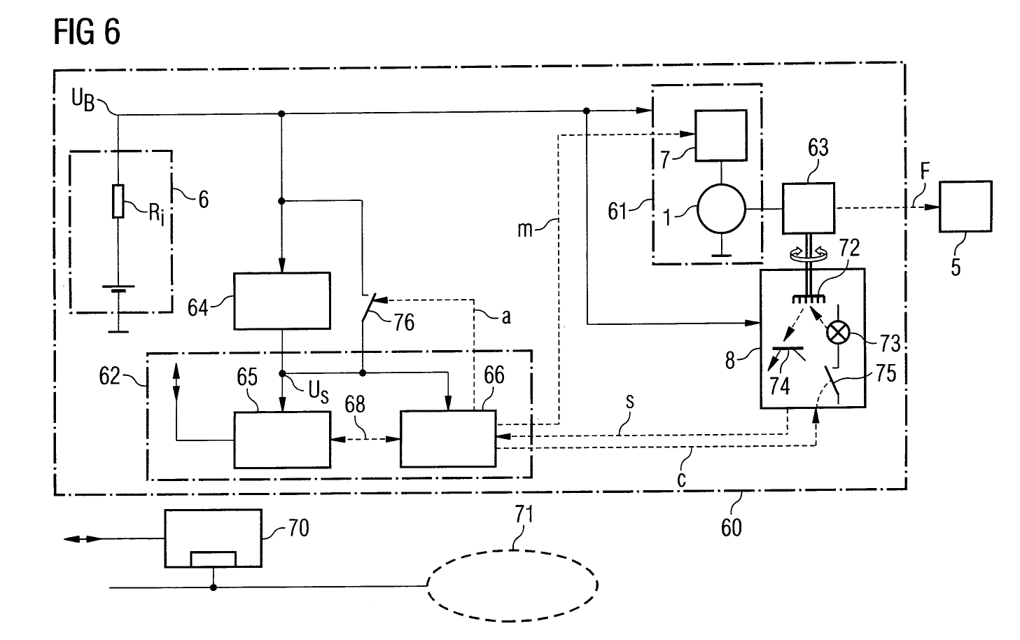

FIG. 6 shows a block diagram for the purpose of illustrating an optimized energy allocation in the battery-fed actuating drive,

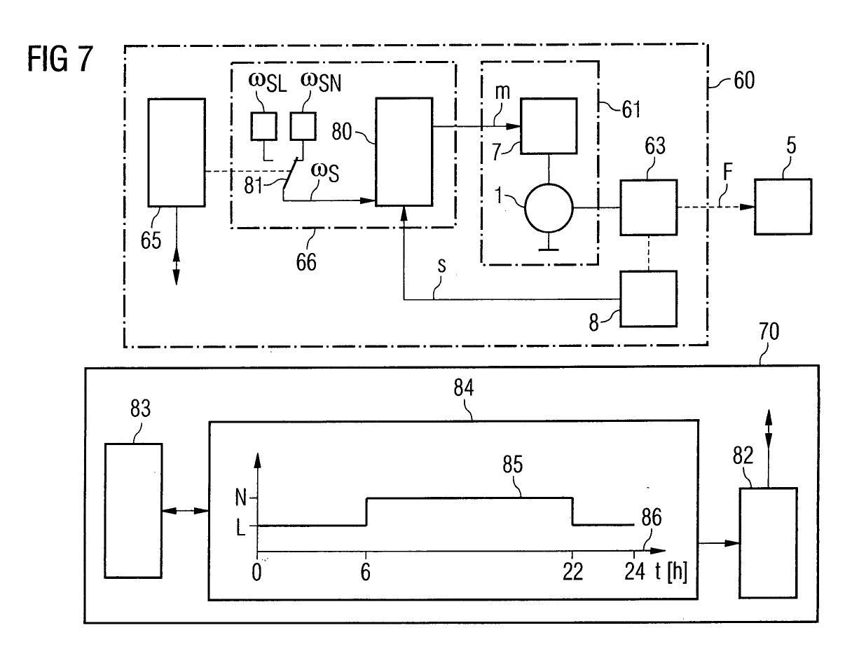

FIG. 7 shows a block diagram relating to the mode of operation of the actuating drive, and

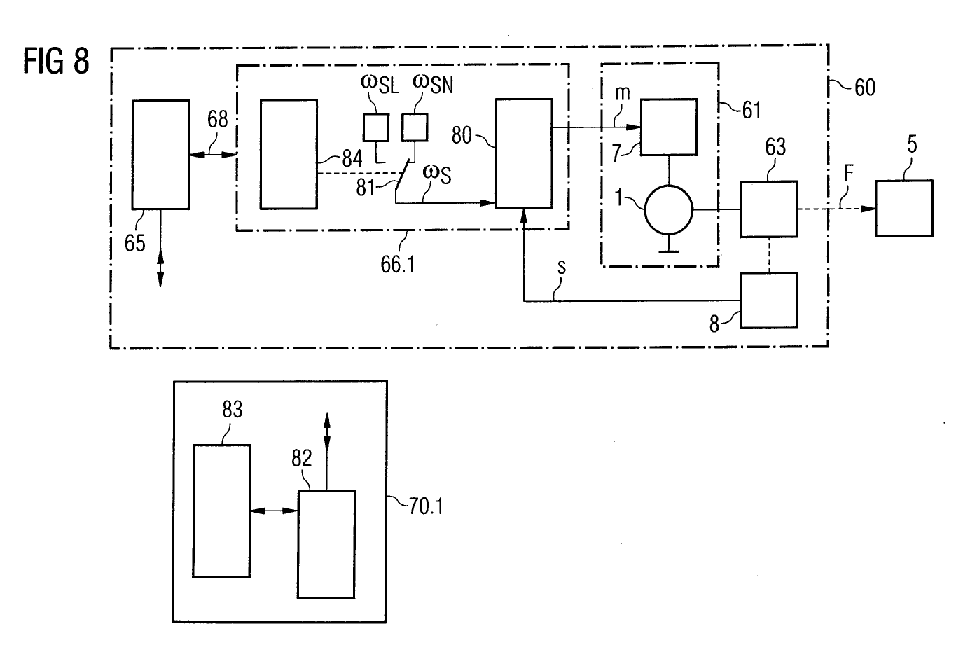

FIG. 8 shows a variant of the actuating drive.

Denoted by numeral 1 in FIG. 1 is an electric motor that is coupled to a transformation element 3 via a gear unit 2. A turning moment M_{M} generated by the electric motor 1 is converted by the gear unit 2 into a drive torque M_{A} transmitted to the transformation element 3. The transformation element 3 transforms the rotary movement generated by the electric motor 1 into a longitudinal movement with a travel H. Owing to the longitudinal movement, a plunger 4 acts on an actuator 5 with an actuating force F. Here, the actuator 5 is a valve with a closing body on which the plunger 4 acts. The valve is typically a continuously adjustable valve in a heating or cooling water circuit, for example a radiator valve.

The electric motor 1 is fed via a motor driver module 7 connected to a voltage source 6.

A sensor device 8 for detecting a rotary movement is arranged at the gear unit 2. A signal s generated by the sensor device 8 is fed to a calculation module 9, for example. A speed signal ω and a position signal p are advantageously generated in the calculation module 9 with the aid of the signal s.

A control device of an actuating drive for the actuator 5 has an inner closed loop and, advantageously, also an outer closed loop. The inner closed loop leads from the sensor device 8 via the speed signal ω, converted by the calculation module 9, and a first comparing device 10 via a first control module 11 to the motor driver module 7. The outer control loop leads from the sensor device 8 via the position signal p, converted by the calculation module 9, and a second comparing device 12 via a second control module 13 to the first comparing device 10, and from there via the first control module 11 to the motor driver module 7. At the second comparing device 12, a desired position signal pₛ of the actuating element is advantageously fed in as command variable.

In an advantageous exemplary embodiment of the actuating drive, the electric motor 1 is a DC motor, and the motor driver module 7 has a driver unit 20 (FIG. 2) and a bridge circuit 21, connected to the battery voltage U_{B}, for driving the electric motor 1. Four electronic switches 22, 23, 24 and 25 of the bridge circuit 21 can be driven by the driver unit 20. The duration and the polarity of a current I_{M} through the electric motor 1 can be controlled from the driver unit 20 by means of corresponding states of the four switches 22, 23, 24 and 25. The driver unit 20 can advantageously be driven via a control signal m.

The control signal m is, for example, a signal whose pulse width can be modulated by the first control module 11.

The driver unit 20 is, for example, an integrated module, while the electronic switches 22, 23, 24 and 25 are implemented, for example, by MOS field effect transistors.

The motor driver module 7 is fundamentally to be adapted in design to a selected motor type, a suitable motor type being selected depending on what is required of the actuating drive, and an electronic commutating circuit adapted to the motor type being used instead of the bridge circuit 21, for example.

The actuator 5 illustrated in simplified form in FIGS. 3a, 3b and 3c is, for example, a valve having a closing body 30 that can be used as actuating element and can be moved toward a valve seat 32 via the plunger 4 against the force of a spring 31. Depending on the direction of rotation of a drive spindle 33 of the electric motor 1, the plunger 4 can be moved to and fro on a longitudinal axis 34 of the closing body 30. Here, the transformation element 3 is an external thread 35, formed on the plunger 4, connected to an internal thread formed on a gearwheel 36.

The valve is illustrated in FIG. 3a in an open state, and so the closing body 30 is in a first final position, and a possible flow rate q for a fluid is 100%. The plunger 4 is also in a final position, an air gap 37 being formed between the plunger 4 and the closing body 30. Particularly when the valve drive can be mounted as universal drive on different valve types, individually achievable final positions will not correspond exactly for closing body and valve drive. It is advantageous to define common final positions of the valve drive and of the closing body after mounting in a calibration method, and to store them advantageously in a travel model in the actuating drive.

In FIG. 3b, the plunger 4 acts with an actuating force F_{B} on the closing body 30, which rests on the valve seat 32 in the state illustrated. In this state, the flow rate q is approximately 0%, the valve being virtually closed.

In the state of the valve illustrated in FIG. 3c, the plunger 4 acts with a larger actuating force F_{C}—referred to the state illustrated in FIG. 3b—on the closing body 30 such that the closing body 30 is pressed into the valve seat 32. The valve seat 32 is made here, for example, from an elastic material that is deformed given the appropriately large actuating force F_{C} of the closing body 30. In this state, the flow rate q is 0%, the valve being tightly closed.

A travel model of a valve is illustrated in FIG. 4 as a fundamental profile H(F). The profile H(F) shows the relationship between the travel H of the closing body 30 and the actuating force F applied to the closing body 30. Down to a minimum value F_{A}, the closing body 30 remains in the first final position illustrated in FIG. 3a. In order for the closing body 30 to be able to move toward the valve seat 32, the plunger 4 working against the spring 31 must overcome an approximately linearly increasing actuating force F. Depicted in the diagram at a certain value F_{B} of the actuating force is an associated reference value H₀ of the travel. The reference value H₀ corresponds to a state of the actuator for which the closing body 30 functioning as actuating element reaches the valve seat 32. An additional travel beyond the reference value H₀ toward a shutoff value H_{0F} requires the actuating force F to be increased beyond the value F_{B} toward the value F_{C} in a strongly disproportionate fashion. However, the disproportionate increase in the actuating force F also requires a sharp increase in the instantaneous power of the electric motor 1 and thus a correspondingly high energy consumption.

In an advantageous control method, in which the flow rate q is to be controlled with the aid of the actuator 5, the reference value H₀ is as far as possible not exceeded if the aim is a minimum energy consumption of the actuating drive, which is advantageously to be the aim in the case of an energy supply by means of a battery.

In an advantageous calibration method for an actuator that has an actuating element with at least one mechanically blocked final position, a force provided by the actuating drive, or a turning moment provided by the actuating drive is advantageously detected and, once a predetermined value of the force or the turning moment has been reached, the current position of the actuating element is detected and stored as mechanical final position of the actuator or of the actuating element, and taken into account in a control method.

The calibration method is initiated, for example, via a start signal k fed to the second control module 13 (FIG. 1). The rotational frequency of electric motor 1 during the calibration method is advantageously held constant at a low value by comparison with a normal operation, this being done by appropriately adapting the speed setpoint ωₛ generated by the second control module 13.

If, for example, the actuator is a thermostat valve that is open in the idle state and whose travel H behaves in principle as illustrated in FIG. 4 as a function of the actuating force F, the closing body is advantageously moved beyond the reference value H₀ of the travel only in the calibration method.

A control range R (FIG. 4) stored in the travel model of the actuating drive is advantageously fixed as a function of the determined reference value H₀. The control range R for the exemplary thermostat valve therefore comprises final positions, useful for control, at H₀—that is to say closed, or flow rate q‥0% and H₁₀₀—that is to say open, or flow rate q=100%.

The information of the signals supplied by the sensor device 8 (FIG. 1) enables a calculation of the current rotational frequency of the electric motor 1 and of the movement of the plunger 4. It is advantageous to store in the calculation module 9 a travel model in which important parameters such as a current position of the closing body, final positions of the closing body 30 and a current speed, preferably the current rotational frequency of the electric motor 1 or, if necessary, the current speed of the closing body 30 are available.

The sensor device 8 preferably comprises a light source and a detector unit tuned to the spectrum of the light source, the light source being directed onto an optical pattern moved by the electric motor 1 such that with the electric motor 1 running light pulses reach the detector unit. The optical pattern is, for example, a disk arranged at the gear unit 2 and having optically reflecting zones, or having holes or teeth which are designed in such a way that a signal from the light source is modulated by the moving optical pattern.

However, it is also possible in principle for the sensor device 8 to be implemented differently, by means of an inductively operating device, for example.

In the second comparing device 12, an error signal (pₛ−p) is formed from the desired position signal pₛ and the position signal p determined by the calculation module 9, and led to the second control module 13. A command variable for the first comparing device 10 is generated in the second control module 13. The command variable is advantageously a speed setpoint ωₛ. In the first comparing device 10, an error signal (ωₛ−ω) is formed from the speed setpoint ωₛ and the speed signal ω determined by the calculation module 9, and led to the first control module 11. The control signal m for the motor driver module 7 is generated in the first control module 11 with the aid of the error signal (ωₛ−ω).

The inner control loop having the first control module 11 keeps the speed of the electric motor 1 constant. Consequently, rotating elements of the gear unit 2 mechanically coupled to the electric motor 1 and of the transformation element 3 are also controlled to constant rotational frequencies in each case in order to neutralize their moments of inertia. Controlling the electric motor 1 to a constant rotational frequency is attended by the advantages that a speed-dependent noise level of the actuating drive is also constant, and can be optimized by suitable selection of the speed setpoint ωₛ. Furthermore, the said speed control is associated with the advantage that self induction of electric motor 1 and moments of inertia of rotating elements of the actuating drive need not be taken into account in the calculation of a current estimate F_{E} for the actuating force F.

One final position of an actuating element can be reliably determined when the actuating element is moved toward the final position, and in the process the current estimate F_{E} for the actuating force F is calculated repeatedly by a computing module 40 (FIG. 5) of the actuating drive and is compared with a predetermined limiting value.

In a first variant, the estimate F_{E} can be calculated only approximately using a linear formula A with the aid of the control signal m applied to the motor driver module 7 and of the battery voltage U_{B}. The product formed from the control signal m, the current value of the battery voltage U_{B} and a first constant k_{U} is reduced by a second constant k_{F}:
F_{E}=U_{B}×k_{U}×m−k_{F} {Formula A}

Owing to the fact that when calculating the estimate F_{E} the speed signal ω attributed to the first comparing device 10 is also used in addition to the control signal m, a formula B yields an improved variant in which the estimate F_{E} can be more accurately calculated. The speed signal ω is multiplied by a third constant k₁₀₇ and the resulting product is subtracted from the estimate F_{E}. The mathematical description of the drive model, and thus the formula B for the improved calculation of the estimate F_{E} therefore runs:
F_{E}=U_{B}×k_{U}×m−k_{ω}×ω−k_{F} {Formula B}

The formula B for calculating this estimate F_{E} is built up in an optimized fashion with the three constants for an implementation suitable for microprocessors. It goes without saying that a suitable estimate of the actuating force can be calculated with the aid of formula B by mathematical conversion, for example associated with an increase in the number of constants used. The three constants k_{U}, k_{ω}, and k_{F} can be determined with little outlay such that the estimate F_{E} can be calculated with sufficient accuracy for determining the final position of the actuating element.

The three constants k_{U}, k_{ω}, and k_{F} take account of characteristic values or properties of the electric motor 1, the motor driver module 7, the gear unit 8 and the transformation element 3.

The computing module 40 comprises a data structure advantageously stored in a microcomputer of the actuating drive, and at least one program routine, which can be executed by the microcomputer, for calculating the estimate F_{E}. In order to calculate the estimate F_{E}, the current battery voltage U_{B} is input, for example via an analog input of the microcomputer, in each case.

In an exemplary implementation of the computing module 40, the properties of the motor driver module 7 are taken into account by the first constant k_{U}, in particular, while it is chiefly characteristic values of electric motor 1 such as, for example, motor constant and DC resistance that are taken into account by the second constant k_{ω}. The gear unit 8 is taken into account by the third constant k_{F}. Furthermore, the efficiency of the actuating drive is taken into account when calculating the estimate F_{E} by having it flow into each of the three constants k_{U}, k_{ω} and k_{F}.

In FIG. 6, 60 denotes the actuating drive for the actuator 5 (FIG. 1). The actuating drive 60 has a drive unit 61, a gear unit 63, a control unit 62, the voltage source 6 (FIG. 1) implemented as a battery, a voltage regulator 64 and the sensor device 8 (FIG. 1).

The control unit 62 is assigned a transceiver unit 65 and a microcomputer unit 66.

The drive unit 61 comprises the motor driver module 7 (FIG. 1) and the electric motor 1 (FIG. 1). The gear unit 63 can be driven by the electric motor 1. The gear unit 63 acting with the actuating force F on the actuator 5 comprises the gear unit 2 (FIG. 1), the transformation element 3 (FIG. 1) and the plunger 4 (FIG. 1).

The transceiver unit 65 and the microcomputer unit 66 are connected to one another via a communication channel 68.

The control signal m (FIG. 1) for driving the motor driver module 7 is generated by the microcomputer unit 66. The signal s supplied by the sensor device 8 is guided to an input of the microcomputer unit 66.

The drive unit 61 and, advantageously, also the sensor device 8 are connected for the purpose of energy supply directly to the battery voltage U_{B} of the battery 6, while the control unit 62 can be fed via the voltage regulator 64 connected to the battery 6.

The actuating drive 60 has an optimized energy management that is controlled by the microcomputer unit 66. In this case, the drive unit 61, the sensor unit 8 and the transceiver unit 65 are advantageously sequentially driven by the microcomputer unit 66 such that the electric energy drawn by the units 61, 8 and 65 occurs in a fashion that is offset in time and serrated and is not cumulative. Moreover, the maximum current consumption of the drive unit 61 is advantageously limited. Current peaks that—conditioned by an internal resistance Rᵢ of the battery 6—would lead to an impermissible drop in the battery voltage U_{B} are avoided by the said sequential driving and the current limitation. In particular, so-called starting current peaks of the drive unit 61 are limited by the current limitation.

A bidirectional wireless data communication link can be built up between the transceiver unit 66 and an external station 70. The external station 70 is, for example, an operator panel, a control center or a higher-level control device. The external station 70 typically transmits a temperature setpoint, a position setpoint or an operating mode to the actuating drive 60 via the data communication link. Moreover, current state information relating to the actuating drive 60 can be transmitted to the external station 70 via the data communication link. In a typical variant, the external station 70 is a node embedded in a computer network 71.

The control unit 62 is fed via the voltage regulator 64 connected to the battery voltage U_{B} so that the actuating drive 60 can communicate reliably to the outside. The voltage regulator 64 ensures a constant operating voltage U_{S} for the control unit 62 independently of the respective current requirement of the drive unit 61 and the sensor unit 8.

The sensor device 8 comprises, for example, an optical pattern 72 that can be moved by the gear unit 63, a light source 73 and a detector unit 74. The signal s transmitted from the sensor device 8 to the microcomputer unit 66 is obtained by the detector unit 74 from the light signal of the light source 73, which is influenced by the optical pattern 72 by a movement of the gear unit 63.

The light source 73 can advantageously be controlled by a clock signal c generated by the microcomputer unit 66 in order to minimize the energy consumption. In an advantageous implementation of the sensor device 8, the latter has a modulation device 75 by means of which the light beam generated by the light source 73 can be modulated. A signal transformation effected by the modulation device 75 is advantageously taken into account in the microcomputer unit 66 by appropriate demodulation of the signal s supplied by the sensor device 8.

The electric motor 1 is controlled in every operating phase to a constant speed by means of the control signal m generated by the control unit 62. Consequently, with reference to its characteristic curve the electric motor 1 is always operated at an optimum operating point independently of the state of the voltage source 6 embodied by the battery.

The control unit 62 is ensured a reliable energy supply in the case of a high battery voltage U_{B} and also in the case of heavy loading of the voltage source 6 caused by the drive unit 61 and the sensor unit 8 because of the fact that the control unit 62 is fed via the voltage regulator 64.

In an advantageous variant of the actuating drive 60, the latter has a switching device 76 for bridging the voltage regulator 64. The switching device 76 can be operated by the microcomputer unit 66 by means of an activation signal a. In the event of an exceptionally low battery voltage U_{B}—that is to say at the end of the service life of the battery—the switching device 76 yields the advantage that the voltage regulator 64 can be bridged automatically by the microcomputer unit 66 such that a voltage drop caused by the voltage regulator 64 is avoided by using the switching device 76 to connect the control unit 62 directly to the battery voltage U_{B} for feeding purposes.

FIG. 7 shows the actuating drive 60 with the drive unit 61, the gear unit 63, the sensor device 8, the microcomputer unit 66 and the transceiver unit 65. The actuator 5 that can be operated by the actuating drive 60 via the actuating force F is, for example, a radiator valve.

Such actuating drives have the property that when operating they generate a speed-dependent noise whose noise level typically increases with increasing speed of actuator motor or actuating gear. The efficiency of the actuating drive, and thus also of the energy consumption for a certain actuating movement is a function of speed. However, an actuating drive optimized with reference to energy consumption causes an impermissibly high noise level for certain applications.

The microcomputer unit 66 has a drive controller 80 by means of which the control signal m guided to the drive unit 61 can be generated, and to which the signal s supplied by the sensor device 8 is ascribed. The speed setpoint ωₛ used by the drive controller 80 to generate the control signal m can be selected via a changeover device 81 from a first speed value ω_{SN} and a second speed value ω_{SL}. The changeover device 81 with the two selectable speed values ω_{SN} and ω_{SL} is advantageously implemented by software of the microcomputer unit 66. The changeover device 81 can be operated via the transceiver unit 65, which can communicate with the microcomputer unit 66.

The drive controller 80 advantageously comprises at least the calculation module 9 described under FIG. 1, the first control module 11 and the first comparing device 10.

The actuating drive 60 can be controlled in a wireless fashion via the external station 70 and comprises a further transceiver unit 82, tuned to the transceiver unit 65 of the actuating drive 60, an operator device 83, and, advantageously, also a time controller 84.

The operator device 83 is a user interface for programming the time controller 84. The time controller 84 fixes a noise level 85 permitted for the actuating drive 60 as a function of a time axis 86. The noise level 85 can advantageously be selected from two values, a user being required here to assign the permitted noise level 85 that is dependent on the time of day to a normal noise level N or a low noise level L via the operator device 83. The time controller 84 advantageously has a programmable day and/or week structure.

One design of the actuating drive 60 according to the invention comprises two operating modes, specifically “normal” and “low-noise” that are advantageously controlled via the time controller 84 on the basis of the time-dependent programmed noise level 85.

The permissible noise level is dependent on the application. If the actuating drive 60 is operated, for example, in a bedroom, the permissible noise level 85 is typically lower in the night time hours than during the day, as illustrated in the exemplary diagram of time controller 84.

The two operating modes are defined via the permissible noise level 85. A noise caused by the actuating drive 60 is fundamentally dependent on the speed of the moving parts of the actuating drive 60. The speed setpoint ωₛ used by the drive controller 80 therefore directly determines the level of the noise caused by the actuating drive 60. The first speed value ω_{SN} is advantageously fixed such that the energy consumption of the actuating drive 60 is minimal when the actuator 5 is operated from a first final position into a second final position. The second speed value ω_{SL}, by contrast, is fixed in a fashion specific to the application and correspondingly lower than the first speed value ω_{SN}, specifically such that the noise caused by the actuating drive 60 does not exceed the low value S. Any points of natural resonance of the gear unit 63 that may be present are advantageously taken into account in fixing the second speed value ω_{SL}.

Measurements in the case of a certain exemplary embodiment of the actuating drive have shown that a reduction in the speed setpoint ωₛ by 100 revolutions per minute yields an audible reduction in the noise level. In the said exemplary embodiment, the lowest battery consumption occurred for 1200 revolutions per minute, and in the “low-noise” operating mode the electric motor was controlled to 800 revolutions per minute.

In the “normal” operating mode, the drive controller 80 controls in accordance with the first speed value ω_{SN} prescribed via the changeover device 81, by contrast, in the “low-noise” operating mode in accordance with the second speed value ω_{SL}. Owing to the fact that the time controller 84 is programmed properly for the application, the actuating drive 60 operates whenever possible in an optimum fashion in terms of energy and, when actually necessary in practice, the low noise level L. The actuating drive 60 can therefore be used in a way that saves battery energy even in the domestic sector.

A further exemplary embodiment of the actuating drive 60 is illustrated in FIG. 8. A variant 66.1 of the microcomputer unit comprises the time controller 84 as well, in addition to the drive controller 80 and the changeover device 81. A variant 70.1 of the external station has the transceiver unit 82 and the operator device 83 via which the time controller 84 can be programmed by means of wireless communication.

1. An actuating drive comprising:
an electric motor for operating an actuator between two final positions, and
a control device for controlling the speed of the electric motor,
wherein the actuating drive can optionally be operated, via a changeover device, either in a first operating mode or in a second operating mode, and in that the control device is configured to control the speed to a first setpoint in the first operating mode, and to a second setpoint in the second operating mode, the first setpoint being fixed in such a way that the energy consumption during operation of the actuator from a first final position into a second final position is minimal, and the second setpoint being fixed in such a way that a noise level generated by the actuating drive in the second operating mode is lower than in the first operating mode.

2. The actuating drive as claimed in claim 1, wherein that the second setpoint is lower than the first setpoint.

3. The actuating drive as claimed in claim 1, wherein the actuating drive includes a transceiver unit configured for wireless communication with a device separated from the actuating drive, and wherein the changeover device of the actuating drive is configured to be controlled from the separate device.

4. The actuating drive as claimed in claim 1, wherein the operating mode of the actuating drive is configured to be controlled as a function of the time of day via a time controller.

5. The actuating drive as claimed in claim 3, wherein the operating mode of the actuating drive is configured to be remotely controlled via a radio link.

6. The actuating drive as claimed in claim 4, wherein the time controller has a daily cycle structure.

7. The actuating drive as claimed in claim 4, wherein the time controller has a weekly cycle structure.

8. An actuating drive comprising:
an electric motor for operating an actuator between two final positions, and
a control device for controlling the speed of the electric motor,
wherein the actuating drive can optionally be operated, via a changeover device, either in a first operating mode or in a second operating mode, and in that the control device is configured to use closed-loop control to control the speed to a first setpoint in the first operating mode, and to a second setpoint in the second operating mode, the first setpoint being fixed in such a way that the energy consumption during operation of the actuator from a first final position into a second final position is minimal, and the second setpoint being fixed in such a way that a noise level generated by the actuating drive in the second operating mode is lower than in the first operating mode.

9. The actuating drive as claimed in claim 8, wherein the actuating drive includes a transceiver unit configured for wireless communication with a device separated from the actuating drive, and wherein the changeover device of the actuating drive is configured to be controlled from the separate device.

10. The actuating drive as claimed in claim 9, wherein the operating mode of the actuating drive is configured to be controlled as a function of the time of day via a time controller.

11. The actuating drive as claimed in claim 10, wherein the operating mode of the actuating drive is configured to be remotely controlled via a radio link.

12. The actuating drive as claimed in claim 10, wherein the time controller has a daily cycle structure.

13. The actuating drive as claimed in claim 10, wherein the time controller has a weekly cycle structure.
